(19) United States
(12) Patent Application Publication
(10) Pub. No.: US 2013/0290032 A1
(43) Pub. Date: Oct. 31, 2013

(54) SYSTEM AND METHOD FOR ELECTRONIC HEALTH RECORD DROPOFF

(71) Applicants: Thomas Netsch, Hamburg (DE); Stewart Young, Hamburg (DE)

(72) Inventors: Thomas Netsch, Hamburg (DE); Stewart Young, Hamburg (DE)

(73) Assignee: KONINKLIJKE PHILIPS N.V., EINDHOVEN (NL)

(21) Appl. No.: 13/994,844

(22) PCT Filed: Nov. 25, 2011
(86) PCT No.: PCT/IB2011/055299

§ 371 Date: Jun. 17, 2013

Related U.S. Application Data
(60) Provisional application No. 61/424,157, filed on Dec. 17, 2010.

(51) Int. Cl. G06Q 50/24; G06Q 10/00

(52) U.S. Cl. CPC G06Q 50/24; G06Q 10/00
USPC 705/3

(57) ABSTRACT

A digital processing device (14, 14′) has first and second independent communication links with a local medical information system (10) and an Internet-based electronic health record (EHR) account (12) of an individual, respectively. The digital processing device presents a first window (W1) indicating content pertaining to the individual stored at the local medical information system and a second window (W2) indicating content stored at the EHR account. A selection (D1, D2, S4, S14) of content to transfer from the EHR account of the individual to the local medical information system or vice versa is received. The selected content is transferred via one of the first or second communication link to an isolation container (50) at the digital processing device, and is transferred via the other of the first or second communication link from the isolation container to the destination local medical information system or EHR account.

The following relates to the medical arts, medical data arts, medical data security arts, and related arts.

An electronic health record (EHR) is a collection of digital health information about individual patients. The concept of an EHR began at the local level, for example in the form of electronic patient information stored in a hospital information system. However, such local records are inaccessible outside of the locality (e.g., the specific hospital maintaining the electronic patient information). As a result, local patient record keeping reduces patient mobility and can create undesirable delays in obtaining patient medical information in an emergency situation. Accordingly, it is increasingly desired to move toward an Internet-based EHR that is accessible from anywhere an Internet connection is available. This is a specific example of a more general transition in information technology toward “cloud” computing.

An example of an Internet-based EHR is Microsoft® Healthvault® (available from Microsoft Corporation, Redmond, Wash., USA). Healthvault® provides an individual with a personal Internet-based EHR account. Compatible devices such as pedometers or so forth can upload health data to the Healthvault® account, and compatible applications authorized by the individual can access the Healthvault® account, or portions thereof, so that the content can be shared with healthcare providers.

However, the use of an Internet-based EHR introduces substantial privacy concerns. The same ubiquitous accessibility that facilitates data portability compromise personal data security of the EHR. Giving hospitals or other medical care providers access to the EHR, even under constraints on the type or level of access, has the potential to expose security faults that could compromise patient data. Moreover, by permitting health care providers access (again, even under constraints) can reduce the individual's control over dissemination of his or her private medical information.

Similar considerations may also lead health care providers such as individual doctors or hospitals to be hesitant to connect their information systems with the EHR. For example, a hospital information system contains large quantities of private patient information, which could be compromised by any security fault in the linkup with the Internet-based EHR.

The following provides new and improved apparatuses and methods as disclosed herein.

In accordance with one disclosed aspect, a system comprises a digital processing device has a first communication link with a local medical information system and a second communication link with an Internet-based electronic health record (EHR) account of an individual. The first and second communication links are independent of one another. The digital processing device performs a method including: authenticating a user as the individual or an authorized agent of the individual; presenting a first window with content stored at the local medical information system, said content pertaining to the individual; presenting a second window with content stored at the EHR account of the individual; receiving from the authenticated user via the second window a selection of content to transfer from the EHR account of the individual to the local medical information system; transferring via the second communication link the selected content from the EHR account of the individual to an isolation container at the digital processing device; and transferring via the first communication link the selected content from the isolation container at the digital processing device to the local medical information system.

In accordance with another disclosed aspect, a system as set forth in the immediately preceding paragraph is provided, in which the digital processing device comprises a general-purpose computer executing software performing the method. The first communication link includes the Internet operating with a first Internet protocol (IP) address and the second communication link includes the Internet operating with a second IP address different from the first IP address. In accordance with another disclosed aspect, a system as set forth in the immediately preceding paragraph is provided, in which the digital processing device comprises a dedicated kiosk configured to perform the method, and in which the first communication link does not include the Internet and the second communication link includes the Internet.

In accordance with another disclosed aspect, a system comprises: a digital processing device has a first communication link with a local medical information system and a second communication link with an Internet-based electronic health record (EHR) account of an individual. The first and second communication links are independent of one another. The digital processing device performs a method including: authenticating a user as the individual or an authorized agent of the individual; presenting a first window indicating content stored at the local medical information system, said content pertaining to the individual; presenting a second window indicating content stored at the EHR account of the individual; receiving from the authenticated user a drag and drop operation dragging an indication of selected content from one of the first window and the second window and dropping the indication of the selected content in the other of the first window and the second window; transferring via the second communication link the selected content from the EHR account of the individual to an isolation container at the digital processing device or transferring via the first communication link the selected content from the local medical information system to the isolation container at the digital processing device; and transferring via the first communication link the selected content from the isolation container at the digital processing device to the local medical information system or transferring via the second communication link the selected content from the isolation container at the digital processing device to the EHR account of the individual.

In accordance with another disclosed aspect, a storage medium stores instructions executable by a digital processing device to perform a method including: establishing a first communication link with a local medical information system and a second communication link with an Internet based electronic health record (EHR) account of an individual, the first and second communication links being independent of one another; authenticating a user as the individual or an authorized agent of the individual; receiving from the authenticated user a selection of content to transfer from the EHR account of the individual to the local medical information system or a selection of content to transfer from the local medical information system to the EHR account of the individual; transferring via the second communication link the selected content from the EHR account of the individual to an isolation container at the digital processing device or transferring via the first communication link the selected content from the local medical information system to the isolation container at the digital processing device; and transferring via the first communication link the selected content from the isolation container at the digital processing device to the local medical information system or transferring via the second communication link the selected content from the isolation container at the digital processing device to the EHR account of the individual.

One advantage resides in providing security isolation for a hospital information system or other local medical information system during transfer of content to or from an Internet-based electronic health record (EHR) account of an individual.

Another advantage resides in providing security isolation for an electronic health record (EHR) account of an individual during transfer of content to or from a hospital information system or other local medical information system.

Another advantage resides in providing a convenient drag-and-drop interface by which an individual or an authorized agent of the individual can transfer content from an electronic health record (EHR) account of the individual to a hospital information system or other local medical information system or vice versa.

Further advantages will be apparent to those of ordinary skill in the art upon reading and understanding the following detailed description.

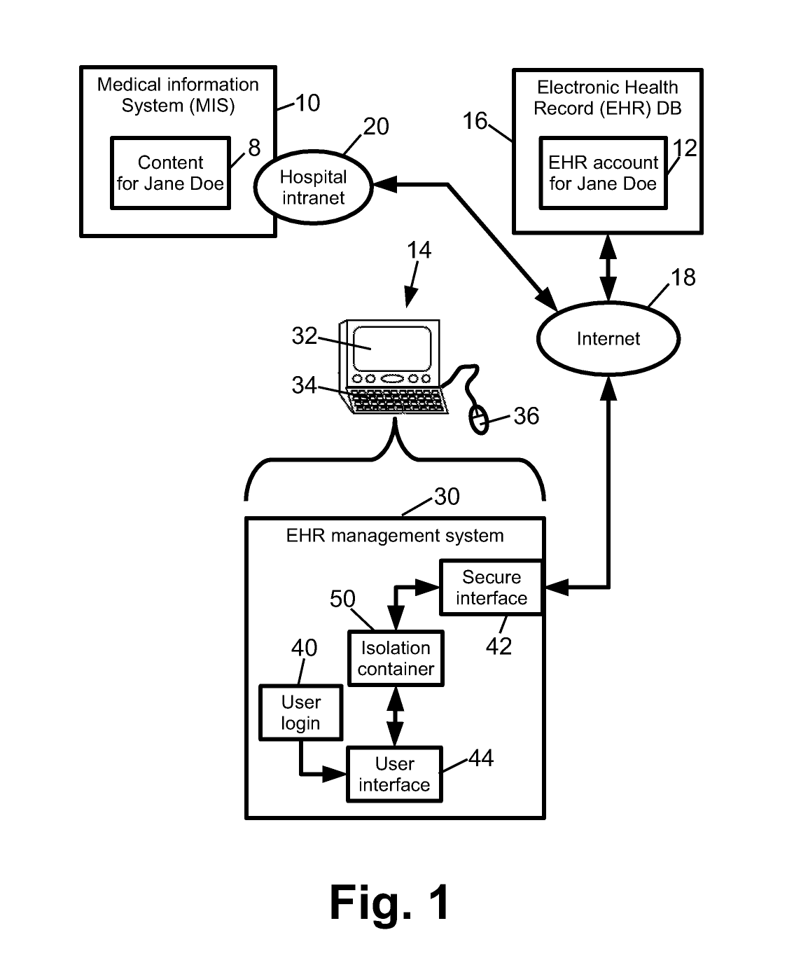

FIG. 1 diagrammatically shows a system enabling an individual or an authorized agent of the individual to transfer medical data between a hospital information system and an Internet-based electronic health record (EHR) account of the individual implemented via a general-purpose computer.

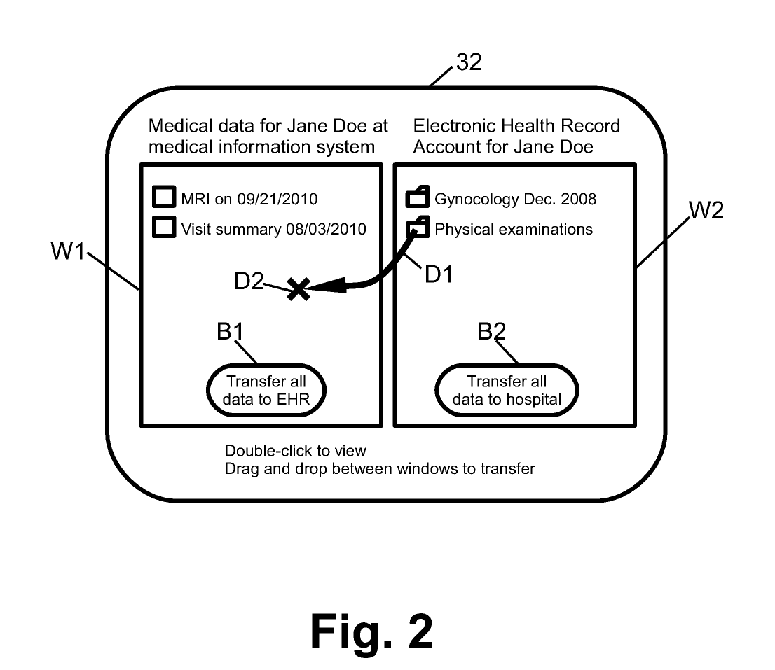

FIG. 2 diagrammatically shows a user interface dialog window suitably implemented by the system of FIG. 1.

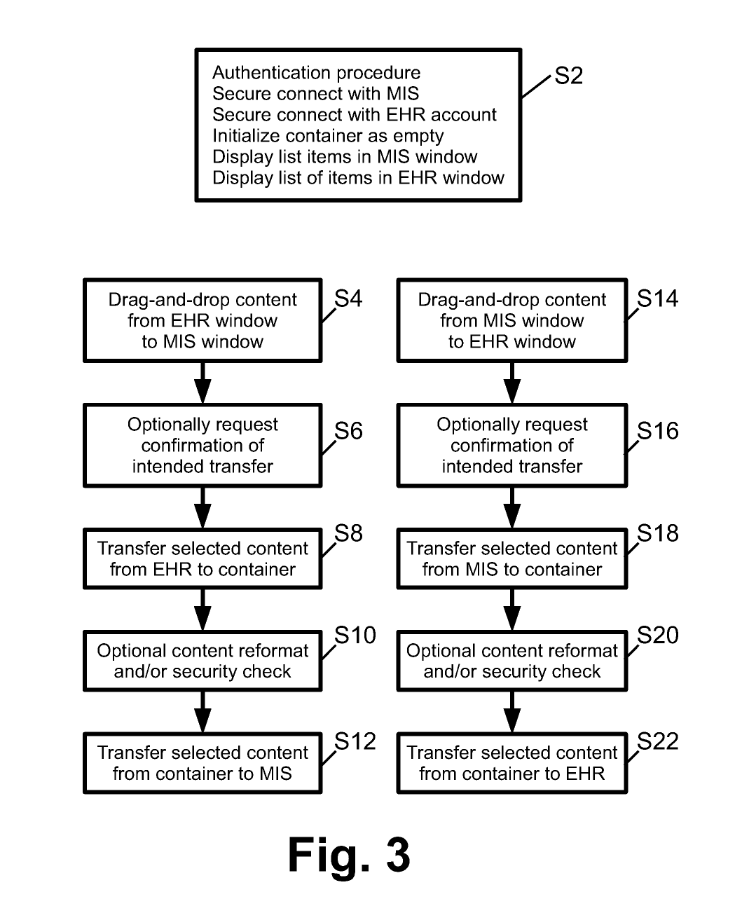

FIG. 3 diagrammatically shows a flow chart for medical data transfer operations suitably performed using the system of FIG. 1.

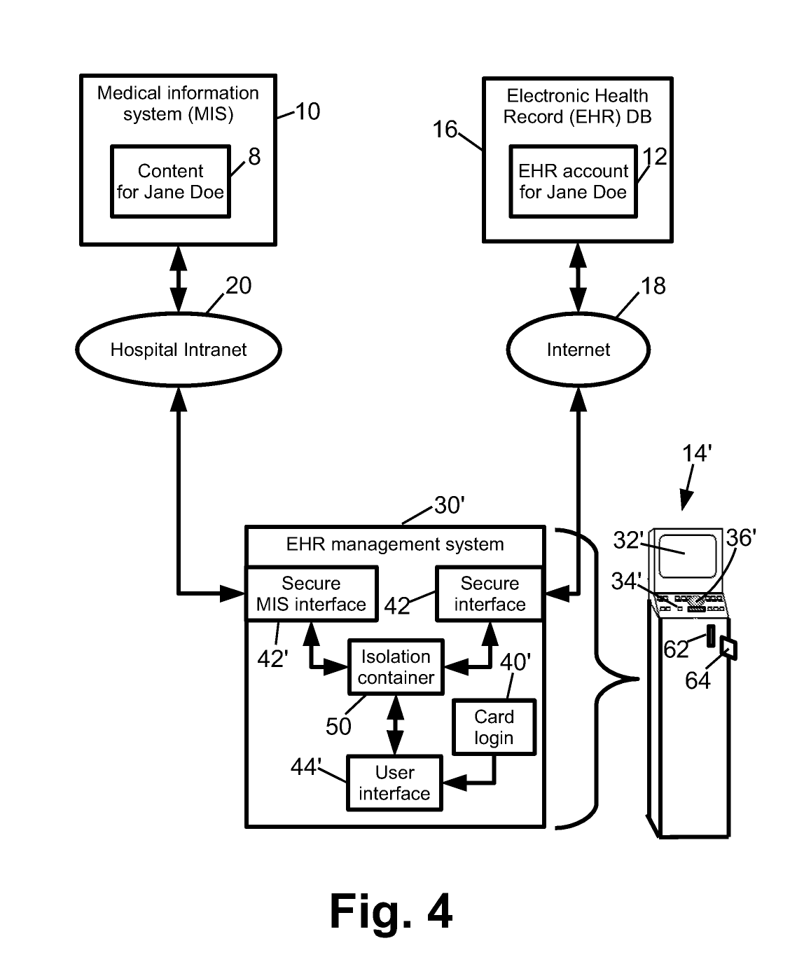

FIG. 4 diagrammatically shows a system enabling an individual or an authorized agent of the individual to transfer medical data between a hospital information system and an Internet-based electronic health record (EHR) account of the individual implemented via a dedicated kiosk.

With reference to FIG. 1, a system is disclosed for enabling an individual or an authorized agent of the individual to transfer content 8 (e.g., medical data) between a local medical information system (MIS) 10 (e.g., hospital information system or HIS) and an Internet-based electronic health record (EHR) account 12 of the individual implemented via a general-purpose computer 14. The Internet-based EHR account 12 is suitably stored in an Internet-based EHR database 16 which may be embodied by one or more physical servers (not shown) which are connected with the Internet 18 and which may, in general, be located anywhere. As such, the Internet-based EHR account 12 is accessible from anywhere an Internet connection is available.

The local medical information system 10 is also connected with the Internet 18, but via an intervening hospital intranet 20 or other intranet, which may by way of illustrative example be embodied as a wired local area network (LAN), wireless local area network (WLAN), hybrid wired/wireless local area network (LAN/WLAN), or so forth. The intranet 20 may employ an Ethernet protocol or the like, and may optionally include a firewall (not illustrated) which blocks undesired Internet protocol (IP) addresses from communicating with the intranet 20. The local medical information system 10 is suitably embodied by a server or other computer, or a network of servers or other computers, that implement a suitable database or collection of databases that store medically related content for patients or other individuals treated at or otherwise served by the hospital or other local medical facility (not illustrated) that maintains local medical information system 10.

For illustrative purposes, the individual corresponding to the EHR account 12 is named “Jane Doe” in FIG. 1. This is merely illustrative, and the individual may in general have any name. Moreover, it is to be understood that the EHR database 16 generally may contain a large number of EHR accounts in addition to the illustrative EHR account 12 for “Jane Doe”. Similarly, the local medical information system 10 may in general contain medically related content for a large number of individuals besides the illustrative content 8 for the individual named “Jane Doe”.

The computer 14 implements an EHR management system 30 that enables an individual or an authorized agent of the individual (e.g., Jane Doe or a Doe family member or other agent authorized by Jane Doe, in the illustrative example) to transfer medical content associated with the individual (e.g., Jane Doe) from the EHR account 12 of the individual to the local medical information system 10, or vice versa. Toward this end, the computer 14 includes a display device 32 for presenting information to a user and one or more user interface devices 34, 36 for receiving inputs from the user. In FIG. 1, the interface devices 34, 36 include a keyboard 34 and a mouse 36. Other input devices are also contemplated, including pointing devices additional to or alternative to the mouse 36 such as a trackball, notebook computer trackpad, or so forth.

The EHR management system 30 implemented by the general-purpose computer 14 includes various functional modules implemented by suitable software having computer executable instructions. An authentication module 40 employs a username/password or other authentication input in order to authenticate a user of the system 30 as the individual corresponding to the EHR account 12 or an authorized agent of this individual. The EHR management system 30 establishes a first communication link with the local medical information system 10 and a second communication link with the EHR account 12 for the individual. Alternatively, separate authentication procedures (possibly including isolated and separate authentication modules, not shown) can be employed for logging onto the EHR account 12 and the EHR management system 30, respectively. The first and second communication links should be separate from one another. In the embodiment of FIG. 1, the first and second communication links both include the Internet 18, and employ different Internet protocol (IP) addresses to ensure independence of the first and second communication links. The first communication link with the local medical information system 10 also includes the intranet 20 which conveys information between the Internet 18 and the local medical information system 10. Preferably, a secure interface 42 is employed in the first and second communication links, for example using encryption to provide link security. Establishing the first and second communication links with the local medical information system 10 and the EHR account 12, respectively, may entail further authentication operations to verify the user is authorized to access the systems 10, 12. These further authentication operations may be performed automatically by the authentication module 40, or may involve receiving further inputs (e.g., further username and/or password information) from the user. As with the intranet 20, it is also contemplated for the computer 14 to employ a firewall (not illustrated) which blocks undesired Internet protocol (IP) addresses from communicating with the computer 14.

With continuing reference to FIG. 1 and with further reference to FIG. 2, once the user is authenticated and the first and second communication links are established, a user interface module 44 causes the display 32 to indicate the individual's content 8 on the local medical information system 10 and the content of the EHR account 12, respectively. FIG. 2 illustrates a suitable display arrangement, which includes a first window W1 indicating content pertaining to the individual stored at the local medical information system 10, and a second window W2 indicating content stored at the EHR account 12 of the individual. By way of illustration, the content pertaining to “Jane Doe” stored at the local medical information system 10 and indicated in the first window W1 includes an indication of a magnetic resonance image (MRI) acquired on Sep. 21, 2010 (i.e., Sep. 21, 2010) and a visit summary for a visit on Aug. 3, 2010 (Aug. 3, 2010). By way of illustration, the content of the EHR account of “Jane Doe” indicated in the second window W2 includes an indication of gynecology data from December 2008 (stored in a first folder or directory) and physical examinations (stored in a second folder or directory). The illustrative folders or directories indicated in the second window W2 are merely illustrative, and the content of the EHR account 12 of the individual may in general be organized in various ways, for example organized into folders or directories, or unorganized and sorted by date or other sorting criteria.

It will be appreciated that the content indications given in windows W1, W2 are not the content itself. A suitable indication of content may, for example, comprise a title or other metadata labeling the content, a thumbnail icon of the content, or so forth. In the illustrative example, if the user wants to view content he or she may “double click” the indication of the content using the mouse 36 (or other pointing device). This causes the content selected by the double-click operation to be downloaded to the computer 14 and displayed on the display 32. Additionally, in the illustrative example if the user want to transfer content from the EHR account 12 of the individual to the local medical information system 10, this is accomplished by a drag-and-drop operation diagrammatically indicated in FIG. 2. In the diagrammatically indicated drag-and-drop operation, the content indication comprising the folder or directory labeled “Physical examinations” is dragged in a drag operation D1 from the second window W2 (representing the EHR account 12) to the first window W1 (representing the local medical information system 10) and dropped in the first window W1 in a drop operation D2.

With continuing reference to FIGS. 1 and 2 and with further reference to FIG. 3, the content transfer operation initiated by the drag-and-drop operation D1, D2 is performed as follows. FIG. 3 diagrammatically shows the method operations. The transfer operations employ an isolation container 50 at the computer 14 to ensure isolation (in conjunction with the independent first and second communication links) between the local medical information system 10 and the EHR account 12, respectively. With reference to FIG. 3, the content transfer is performed after preparatory operations S2 including the user authentication procedure performed by the authentication module 40, establishment of the independent first and second communication links, initialization of the isolation container 50 as empty, and display of the windows W1, W2. The drag-and-drop operation D1, D2 diagrammatically shown in FIG. 2 corresponds to a drag-and-drop operation S4 in FIG. 3. This drag-and-drop operation S4 is optionally confirmed in a confirmatory operation S6. The operation S6 may, for example, entail displaying “Do you really want to transfer <content> from your electronic health record to <hospital>?” and receiving either a confirmation (e.g., selection of “Y”, or clicking on an “OK” button shown on the display 32, or so forth) or a cancellation (e.g., selection of “N”, or clicking on a “Cancel” button shown on the display 32, or so forth). In some embodiments, a configuration file or dialog (not shown) enables the user to configure the system 30 to either perform or omit the confirmation operation S6; alternatively, it is also contemplated for the confirmation operation S6 to be entirely unavailable.

Once the transfer of selected content is initiated in the drag-and-drop operation S4 and optionally confirmed in the operation S6, the actual transfer of the selected content is performed. In an operation S8 the selected content is transferred from the EHR account 12 to the isolation container 50 at the computer 14. The operation S8 entails downloading the selected content from the EHR account 12 via the second communication link (e.g., the Internet 18 in the illustrative embodiment of FIG. 1). In an optional operation S10, the content in the isolation container 50 at the computer 14 is optionally reformatted into a format suitable for storage at the local medical information system 10, and/or is optionally analyzed by anti-virus software or another security check. The optional reformatting is suitably performed if the selected content is stored at the EHR account 12 in a format that is different from and/or unreadable by the local medical information system 10. Such reformatting may include, for example: converting an image from one image format to another (e.g., JPEG to TIFF, or so forth); converting from one word processing format to another or to rich text format; and so forth. The content at the isolation container 50 is then transferred to the local medical information system 10 (e.g., the hospital information system or HIS in the illustrative example) in an operation S12. The operation S12 entails uploading the selected content from the isolation container 50 to the local medical information system 10 via the first communication link (e.g., the Internet 18 and the hospital intranet 20 in the illustrative embodiment of FIG. 1).

It will be noted that the user who has been authenticated as the individual (e.g., “Jane Doe”) or an authorized agent of the individual controls precisely which content is conveyed to the local medical information system 10. In the illustrative example of FIG. 2, by way of illustrative example, the gynecology data from December 2008 is not selected content and is therefore not transferred to the local medical information system 10. This is the individual's choice e.g., Jane Doe may not consider the dated gynecology information from December 2008 to be relevant to the medical matter currently being addressed by the hospital.

With continuing reference to FIGS. 1-3, the EHR management system 30 also enables transfer of content in the opposite direction, that is, from the local medical information system 10 to the EHR account 12 of the individual. This is diagrammatically shown in FIG. 3 by the set of operation S14, S16, S18, S20, S22 which parallel respective operations S4, S6, S8, S10, S12 for transfer from the EHR account 12 to the local medical information system 10. The transfer of selected content of the local medical information system 10 is initiated in a drag-and-drop operation S14 (which in this case starts in the window W1 and drops in the window W2) and is optionally confirmed in an operation S16. The actual transfer of the selected content is then performed. In an operation S18 the selected content is transferred from the local medical information system 10 to the isolation container 50 at the computer 14. The operation S18 entails downloading the selected content from the local medical information system 10 via the first communication link (e.g., the Internet 18 and the hospital intranet 20 in the illustrative embodiment of FIG. 1). In an optional operation S20, the content in the isolation container 50 at the computer 14 is optionally reformatted into a format suitable for storage at the EHR account 12, and/or is optionally analyzed by anti-virus software or another security check. The content at the isolation container 50 is then transferred to the EHR account 12 in an operation S22. The operation S22 entails uploading the selected content from the isolation container 50 to the EHR account 12 via the second communication link (e.g., the Internet 18 in the illustrative embodiment of FIG. 1).

With particular reference to FIG. 2, the EHR management system 30 optionally may provide one or more mechanisms for performing bulk transfer of content. In the illustrative example of FIG. 2, the second window W2 includes a user selectable button B2 which, if selected, carries out the operations S6, S8, S10, S12 for transfer from the EHR account 12 to the local medical information system 10 with the selected content being all content stored in the EHR account 12. In analogous fashion, the first window W1 includes a user selectable button B1 which, if selected, carries out the operations S16, S18, S20, S22 for transfer from the local medical information system 10 to the EHR account 12 with the selected content being all content pertaining to the individual stored in the local medical information system 10. Moreover, although not illustrated, in some embodiments the drag-and-drop operations S4, S14 may include the use of “lassoing” or other group selection by which a group of content may be selected and dragged from one window to the other window. Still further, the illustrated drag-and-drop approach for selecting content for transfer from the local medical information system 10 to the EHR account 12 (or vice versa) may be augmented or replaced by other selection approaches. By way of illustrative example (not illustrated), another suitable approach is to include checkboxes associated with each indication of content in the windows W1, W2, and the user then checks the checkboxes associated with the content to be transferred and chooses a “Transfer” button (not shown) to initiate the transfer. Still further, while user interfacing employing the illustrative mouse 36 is shown, other user interfacing may be additionally or alternatively used, such as user interfacing employing “hot keys”, i.e. key or key combinations having predetermined associated operations.

The user interface 44 may be variously embodied. In some instances, the user interface 44 comprises a web browser for performing the presenting of the windows W1, W2 and the user input receiving operations D1, D2, S4, S14. Alternatively, the user interface may be a dedicated program implementing the EHR management system 30, or may comprise a combination of a web browser and suitable “plug-in” modules that interoperate with the web browser to define the EHR management system 30.

In the embodiment of FIG. 1, security of the respective local medical information system 10 and EHR account 12 is provided by the combination of: (1) using independent first and second communication links by which the system 30 independently communicated with the local medical information system 10 and EHR account 12, respectively; (2) employing the isolation container 50 to further ensure that no direct communication occurs between the local medical information system 10 and EHR account 12; (3) the optional security check component of the optional operations S10, S20; and (4) user authentication provided by the user authentication module 40 which ensures that only the individual or an authorized agent of the individual performs content transfers using the system 30. Although the system of FIG. 1 provides substantial security, it is possible that the hospital or other local medical care provider maintaining the HIS or other local medical information system 10 may nonetheless remain concerned about security, and may be unwilling to allow external access to the system 10 via the Internet 18.

With reference to FIG. 4, in another embodiment the general purpose computer 14 is replaced by a dedicated kiosk 14′, which includes a display 32′ corresponding to the computer display 32. The dedicated kiosk 14′ includes user interface devices 34′, 36′ which in the illustrative embodiment comprise a specialized keyboard 34′ including only a few keys for performing various EHR management operations, and a trackball 36′ that serves as a pointing device analogous to the mouse 36 of the embodiment of FIG. 1. The dedicated kiosk 14′ embodies a variant EHR management system 30′ that implements data transfers using the isolation container 50 as already described. However, the dedicated kiosk 14′ includes a different configuration for the first and second communication links communicating with the local medical information system (MIS) 10 (e.g., a Hospital Information System or “HIS”) and the EHR account 12, respectively.

In the embodiment of FIG. 4, the first communication link between the kiosk 14′ and the local medical information system 10 is via the intranet 20 only, and does not include the Internet 18. A secure interface 42′ provides a dedicated connection of the kiosk 14′ with the intranet 20 which provides enhanced security by not including the Internet 18. The second communication link between the kiosk 14′ and the Internet-based EHR account 12 must include the Internet 18, and can be implemented in various ways. In the illustrative embodiment of FIG. 4, the kiosk 14′ connects to the EHR account 12 directly through the Internet 18 via the dedicated secure Internet interface 42 already described with reference to FIG. 1. In this way, communications with the EHR account 12 do not pass through the intranet 20, thus providing enhanced security for the HIS 10 and hospital intranet 20.

In an alternative embodiment (not shown), the second communication link is via the intranet 20 and the Internet 18, with the connection between the intranet 20 and the Internet 18 being provided by a secure Internet gateway component having a robust firewall or other security measures, and with different IP addresses being used for the first and second communication links to ensure their independence.

A user interface 44′ corresponds to the user interface 44 of the embodiment of FIG. 1 and performs equivalent functionality. However, the user interface 44′ is a dedicated user interface designed to operate on the dedicated kiosk 14′. In similar fashion, the user authentication module 40 of FIG. 1 is replaced by a key- or card-based authentication module 40′ that operates in conjunction with a physical key or card reader 62 of the dedicated kiosk 14′. A physical identification key or card 64 owned by or assigned to “Jane Doe” (in the illustrative embodiment) is received at the key or card reader 62 of the dedicated kiosk 14′, and the user is authenticated as the individual (e.g., “Jane Doe”) or an authorized agent of the individual based on identifying electronic content stored on or in the physical identification key or card 64.

The EHR management system 30′ operates analogously to the system 30 of FIG. 1, with drag-and-drop operations being performed by the user via the trackball 36′ (instead of via the mouse 36 in the case of the embodiment of FIG. 1). The display 32′ of the EHR management system 30′ suitably displays the windows W1, W2 of FIG. 2, and the system 30′ suitably performs the preparatory operation S2 and content transfer operations S4, S6, S8, S10, S12, S14, S16, S18, S20, S22 of FIG. 3.

In addition to the security features provided by the embodiment of FIG. 1 (e.g., using independent first and second communication links, employing the isolation container 50, the optional security check component of the optional operations S10, S20; and user authentication provided by the user authentication module 40), the system of FIG. 4 provides still further enhanced security by employing the local first communication link including the intranet 20 but omitting the Internet 18, and by employing the enhanced authentication module 40′ utilizing the identification key or card reader 62. Moreover, in some embodiments the kiosk 14′ is physically located at the hospital or other institution that maintains the HIS or other local medical information system 10. This provides further control over access to the HIS or other local medical information system 10 via the EHR management system 30′, and such access is limited by limited availability of the kiosks 14′ in the hospital or other institution.

It is also contemplated to provide both the system of FIG. 1 (for example to provide at-home access to EHR management) and the system of FIG. 4 (for example to provide EHR management capability in the hospital).

The disclosed EHR management systems 30, 30′ are embodied by the illustrated general-purpose computer 14 and dedicated kiosk 14′, respectively. More generally, the disclosed EHR management systems and methods may be embodied by any digital processing device having suitable display and user input components, and may by way of further example be embodied by a tablet computer, a cellular telephone, or so forth. Still further, the disclosed EHR management may be embodied by a storage medium storing instructions executable by the illustrative computer 14, kiosk 14′, or other digital processing device to perform the disclosed EHR management methods. By way of illustrative example, such a storage medium may comprise a hard disk or other magnetic storage medium, and/or an optical disk or other optical storage medium, and/or random access memory (RAM), read-only memory (ROM), FLASH memory, or another electronic storage medium, or so forth.

This application has described one or more preferred embodiments. Modifications and alterations may occur to others upon reading and understanding the preceding detailed description. It is intended that the application be construed as including all such modifications and alterations insofar as they come within the scope of the appended claims or the equivalents thereof.

1. A system comprising:
a digital processing device having a first communication link with a local medical information system and a second communication link with an Internet-based electronic health record (EHR) account of an individual, the first and second communication links being independent of one another, the digital processing device performing a method including:
authenticating a user as the individual or an authorized agent of the individual,
presenting a first window with content stored at the local medical information system, said content pertaining to the individual,
presenting a second window with content stored at the EHR account of the individual,
receiving from the authenticated user via the second window a selection of content to transfer from the EHR account of the individual to the local medical information system,
transferring via the second communication link the selected content from the EHR account of the individual to an isolation container at the digital processing device, and
transferring via the first communication link the selected content from the isolation container at the digital processing device to the local medical information system.

2. The system as set forth in claim 1, wherein the digital processing device comprises a general-purpose computer executing software performing the method, the first communication link includes the Internet operating with a first Internet protocol (IP) address and the second communication link includes the Internet operating with a second IP address different from the first IP address.

3. The system as set forth in claim 2, wherein the first communication link further includes an intranet conveying information between the Internet and the local medical information system.

4. The system as set forth in claim 1, wherein the general-purpose computer executes software including a web browser for performing the presenting and receiving operations.

5. The system as set forth in claim 1, wherein the digital processing device comprises a dedicated kiosk configured to perform the method, the first communication link does not include the Internet and the second communication link includes the Internet.

6. The system as set forth in claim 5, wherein the first communication link includes an intranet conveying information between the dedicated kiosk and the local medical information system.

7. The system as set forth in claim 1, wherein the authenticating operation includes:
receiving a physical identification key or card at a physical key or card reader of the dedicated kiosk and authenticating the user as the individual or an authorized agent of the individual based on identifying electronic content stored on or in the physical identification key or card.

8. The system as set forth in claim 1, wherein the receiving operation includes:
receiving a drag-and-drop operation from the authenticated user in which the user drags an indication of the selected content from the second window to the first window.

9. The system as set forth in claim 1, wherein the selection of content includes one or more medical images.

10. The system as set forth in claim 1, wherein the method further includes:
after the transferring via the second communication link and before the transferring via the first communication link, performing a data reformatting operation on the selected content in the isolation container.

11. The system as set forth in claim 1, wherein the method further includes:
after the transferring via the second communication link and before the transferring via the first communication link, performing a security check on the selected content in the isolation container.

12. The system as set forth in claim 1, wherein the local medical information system is a hospital information system.

13. The system as set forth in claim 1, wherein the second communication link with the Internet-based EHR account of the individual employs encryption.

14. The system as set forth in claim 1, wherein the method further includes:
receiving from the authenticated user via the first window a selection of content to transfer from the local medical information system to the EHR account of the individual,
transferring via the first communication link the selected content from the local medical information system to the isolation container at the digital processing device, and
transferring via the second communication link the selected content from the isolation container at the digital processing device to the EHR account of the individual.

15. A system comprising:
a digital processing device having a first communication link with a local medical information system and a second communication link with an Internet-based electronic health record (EHR) account of an individual, the first and second communication links being independent of one another, the digital processing device performing a method including:
authenticating a user as the individual or an authorized agent of the individual,
presenting a first window indicating content stored at the local medical information system, said content pertaining to the individual,
presenting a second window indicating content stored at the EHR account of the individual,
receiving from the authenticated user a drag-and-drop operation dragging an indication of selected content from one of the first window and the second window and dropping the indication of the selected content in the other of the first window and the second window,
transferring via the second communication link the selected content from the EHR account of the individual to an isolation container at the digital processing device or transferring via the first communication link the selected content from the local medical information system to the isolation container at the digital processing device, and
transferring via the first communication link the selected content from the isolation container at the digital processing device to the local medical information system or transferring via the second communication link the selected content from the isolation container at the digital processing device to the EHR account of the individual.

16. The system as set forth in claim 15, wherein:
the digital processing device comprises a general-purpose computer executing software performing the method,
the first communication link includes the Internet operating with a first Internet protocol (IP) address and an intranet conveying information between the Internet and the local medical information system, and
the second communication link includes the Internet operating with a second IP address different from the first IP address.

17. The system as set forth in claim 15, wherein the digital processing device comprises a dedicated kiosk configured to perform the method, the first communication link does not include the Internet and the second communication link includes the Internet.

18. The system as set forth in claim 1, wherein the selection of content includes one or more medical images.

19. The system as set forth in claim 1, wherein the local medical information system is a hospital information system.

20. A storage medium storing instructions executable by a digital processing device to perform a method including:
establishing a first communication link with a local medical information system and a second communication link with an Internet-based electronic health record (EHR) account of an individual, the first and second communication links being independent of one another;
authenticating a user as the individual or an authorized agent of the individual;
receiving from the authenticated user a selection of content to transfer from the EHR account of the individual to the local medical information system or a selection of content to transfer from the local medical information system to the EHR account of the individual;
transferring via the second communication link the selected content from the EHR account of the individual to an isolation container at the digital processing device or transferring via the first communication link the selected content from the local medical information system to the isolation container at the digital processing device; and
transferring via the first communication link the selected content from the isolation container at the digital processing device to the local medical information system or transferring via the second communication link the selected content from the isolation container at the digital processing device to the EHR account of the individual.

21. The storage medium as set forth in claim 20, wherein the receiving operation employs a drag-and-drop operation to select the content to transfer from the EHR account of the individual to the local medical information system or to select the content to transfer from the local medical information system to the EHR account of the individual.
